(19) United States
(12) Patent Application Publication
(10) Pub. No.: US 2018/0144602 A1
(43) Pub. Date: May 24, 2018

(54) Method and System for Mold Prevention in Rental Units Through Wireless Monitoring of Temperature and Humidity Using Internet Cloud Servers

(71) Applicant: IoT Cloud Technologies Inc., Calgary (CA)

(72) Inventor: Matthew James Lewis, Calgary (CA)

(21) Appl. No.: 15/673,968

(22) Filed: Aug. 10, 2017

Related U.S. Application Data
(60) Provisional application No. 62/367,161, filed on Jul. 27, 2016.

(51) Int. Cl. G08B 21/18; H04Q 9/00

(52) U.S. Cl. CPC G08B 21/182; F24F 2011/0071; H04Q 9/00

(57) ABSTRACT

A mold prevention or mitigation solution includes one or more humidity monitors installed in an indoor environment and operable to monitor a current relative therein, an alarm server communicable with said one or more humidity monitors over a data network, and a network connection by which the alarm server is communicable with one or more meteorological server that provides current weather data. The alarm server receives a current relative humidity value from the one or more humidity monitors, automatically obtains a current outdoor temperature from the meteorological server(s), automatically adjusts a humidity alarm set point based on the current outdoor temperature, and automatically compares the set point against the current relative humidity value to trigger an alert in the event that said current relative humidity value exceeds the humidity alarm set point.

### CROSS REFERENCE TO RELATED APPLICATIONS

This application claims benefit under 35 U.S.C. 119(e) of Provisional Application Ser. No. 62/367,161, filed Jul. 27, 2016.

### FIELD OF THE INVENTION

The present invention relates generally to methods and systems for preventing or mitigating mold growth in indoor environments.

### BACKGROUND

Development of mold within occupied indoor environments is problematic for the health of occupants, for example causing allergic reactions and respiratory problems. Conventional ways of dealing with mold growth are reactive approaches, where only once mold growth has been detected are subsequent steps taken to remove it. Often, by the time mold is detected, indoor air quality has already been substantially degraded, and costly and intensive mold remediation procedures are required, and may involve demolition and replacement of building materials or entire structures.

Prior attempts to provide mold preventative measures are disclosed in U.S. Patent Application Publications 2013/0133404 and US2015/0145677, where sensors monitor indoor temperature and humidity to detect mold-prone conditions and trigger a warning alarm.

However, there remains room for improvement, and applicant has developed a unique solution with novel and inventive aspects unforeseen by the prior art.

### SUMMARY OF THE INVENTION

According to a first aspect of the invention, there is provided a computer- implemented method of preventing or mitigating mold growth, said method comprising:

(a) within an indoor environment to be monitored, automatically measuring a current relative humidity value of said indoor environment;

(b) automatically obtaining a current outdoor temperature, and based on said current outdoor temperature, automatically adjusting a humidity alarm set point;

(c) automatically comparing said humidity alarm set point against said current relative humidity value in the indoor environment; and

(d) in response to determination that said current relative humidity value exceeds the humidity alarm set point, providing an alert to one or more personnel.

Preferably step (b) comprises obtaining said current outdoor temperature from one or more meteorological servers situated remotely from said indoor environment.

Preferably step (a) further comprises forwarding said current relative humidity value to an alarm server, step (c) comprises obtaining of the current outdoor temperature from the one or more meteorological servers by said alarm server and comparison of said humidity alarm set point against said current relative humidity value by said remote alarm server, and step (d) comprises generating and forwarding of the alert by said alarm server.

According to a second aspect of the invention, there is provided a mold prevention or mitigation system comprising:

one or more humidity monitors installed in an indoor environment and operable to monitor a current relative humidity therein;

an alarm server communicable with said one or more humidity monitors over a data network; and

an Internet connection by which the alarm server is communicable with one or more meteorological server that provide current weather data,

wherein the alarm server is configured to receive a current relative humidity value from the one or more humidity monitors, automatically obtain a current outdoor temperature from the one or more meteorological servers, automatically adjust a humidity alarm set point based on said current outdoor temperature, automatically compare said humidity alarm set point against said current relative humidity value, and in response to determination that said current relative humidity value exceeds the humidity alarm set point, send an alert to one or more personnel.

By taking into account the current outdoor temperature of a geographic area in which the indoor environment is located, embodiments of the present invention improve on prior systems that determine alarm conditions solely on the basis of indoor conditions, by better predicting the likelihood of condensation formation within the indoor environment, for example on the inside surface of a window that separates humid inside air from cooler outside air.

### BRIEF DESCRIPTION OF THE DRAWINGS

FIG. 1 illustrates a Wireless Humidity and Temperature Monitoring and Alarm System according to one embodiment of the present invention.

FIG. 2 illustrates one of the Wireless Humidity Monitors used in the system of FIG. 1.

### DETAILED DESCRIPTION OF PREFERRED EMBODIMENTS

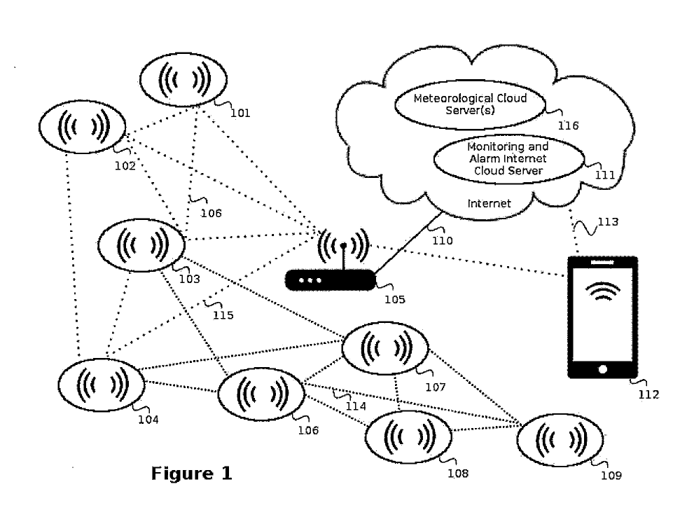

The system in FIG. 1 includes the Wireless Humidity and Temperature Monitors (101, 102, 103, 104), that are connected directly (115) to a Wi-Fi access point (105) or through a Wi-Fi Mesh Network (106).

Wireless Humidity and Temperature Monitors (103, 104, 106, 107, 108. 109) are equipped with ZigBee™ Modules. Wireless Humidity and Temperature Monitors (106, 107, 108. 109) connect to the Wi-Fi through Wireless Humidity and Temperature Monitors (103, 104). The Wi-Fi access point is connected to the Internet (110) allowing the Wireless Humidity and Temperature Monitors to send and receive data to and from the Monitoring and Alarm Internet Cloud Server (111). The User Interface (112) is used to access the Monitoring and Alarm Internet Cloud Server (111) through the local Wi-Fi (105), mobile or direct internet connection (113). A Wi-Fi Mesh Network (106) and or ZigBee™ Mesh Network (114) is used to extend the number of units monitored and or the range (distance) between the monitored units. The Meteorological Cloud Server(s) (116) are accessed by the Monitoring and Alarm Internet Cloud Server (111) to obtain the local up to date weather conditions (Humidity and Temperature).

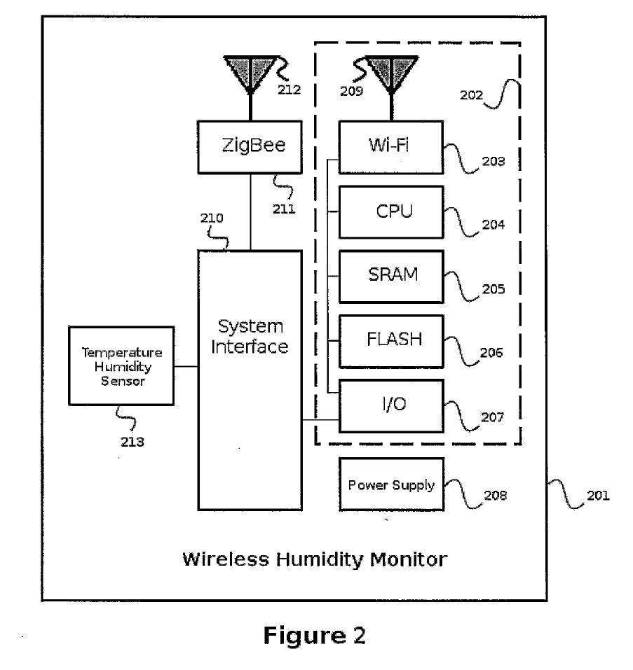

With reference to the representative Wireless Humidity Monitor (201) in FIG. 2, each Wireless Humidity Monitor contains a computer system (202) with: Central processing unit CPU (204), Static Random Access Memory SRAM (205), Flash Memory FLASH 206, Input I Output I/O (207), Wi-Fi IEEE 802.11 /b/g/n (203), Wi-Fi Antenna (209), System Interface (210), Digital Temperature and Humidity Sensors (213), Power Supply (208) and an optional ZigBee™ IEEE 802.15.4 radio (211) with ZigBee™ antenna (212).

The Power Supply (208) supplies regulated power to all the systems within the Wireless Humidity Monitor (201) and its internal and external sensors. The Power Supply may be powered by a standard 5V adapter or Lithium Battery. Each Wireless Humidity Monitor with a ZigBee™ radio (211) can also act as a bridge to relay data from the ZigBee™ mesh network to the Wi-Fi network.

Each monitor thus features non-transitory computer readable memory coupled to the processor, and on which there are stored statements and instructions executable by the processor perform the functions, operations, calculations and other steps described herein, including receipt of current temperature and humidity values from the digital sensors via the I/O, and forwarding of same to Alarm Cloud Server via the internet access point. Likewise, each Alarm Server, in a known manner, features one or more processors with non-transitory computer readable memory coupled to the processor, and on which there are stored statements and instructions executable by the processor perform the functions, operations, calculations and other steps described herein. Particular software code and algorithms for performing the described steps will be within the purview of the person of ordinary skill in the art upon a reading of the generally described steps outlined herein.

The Wireless Humidity Monitor transmits the Rental Unit's Relative Humidity and Temperature readings through a local Wi-Fi IEEE 802.11 /b/g/n network to an Internet access point. The Humidity and Temperature readings are then sent through the Internet to a Monitoring and Alarm Cloud Server. Software running on the Monitoring and Alarm Cloud Server records and analyzes the data. The Monitoring and Alarm Cloud Server also acquires the local outside meteorological (weather) data (temperature and relative humidity) from Meteorological Cloud Server(s). The Software running on the Monitoring and Alarm Cloud Server determines if a risk of condensation exists within the monitored rental unit by comparing the Rental Unit's Relative Humidity with a Relative Humidity alarm Floating Set Point. The Relative Humidity alarm Floating Set Point is automatically adjusted based on outdoor temperature by software running on the Humidity Monitoring and Alarm Cloud Server.

As the outside temperature drops the indoor Relative Humidity alarm Floating Set Point is automatically lowered. As the outside temperature gets warmer the indoor Relative Humidity alarm Floating Set Point is automatically raised. A risk of condensation alarm is triggered when the Rental Unit's Relative Humidity exceeds the Relative Humidity Floating Set Point.

When a risk of condensation alarm is triggered the Humidity Monitoring and Alarm Cloud Server automatically sends an email alert to the property manager and or building owner. The alarm notification email contains the current status of the rental unit and rental unit number. Using an internet enabled device (cell phone, tablet, laptop or desktop computer) the property manager and or building owner can log into the Monitoring and Alarm Cloud Server to get present and historical Relative Humidity and Temperature data, time and date stamped alarms, update Rental Unit information, adjust alarm settings, and alarm email notification lists.

To extend the range of the Wi-Fi access point(s) the Wireless Humidity Monitors form a Wireless Mesh Network. The Mesh Network uses the Wi-Fi transceivers or it can operate using optional ZigBee™ IEEE 802.15.4 based modules. Relative Humidity and Temperature readings are relayed through the Mesh Network to the Wireless Internet Access Point(s).

When the ZigBee™ modules are used, the Relative Humidity and Temperature Monitors closest to the Wi-Fi access point(s) forward Relative Humidity and Temperature data from the ZigBee™ network through the Wi-Fi network.

Preferably, the Meteorological Cloud Server(s) are meteorological HTTP web servers. Retrieving the meteorological data from existing third party meteorological HTTP web servers 403 provides the system with universality, allowing it to operate in any geographic region within which meteorological data is measured and posted online on publicly accessible web pages. No specialized communication protocols are required to interact with government weather bureaus or other non-HTTP resources. The alarm server may comprise a database storing the geographic locations of multiple buildings each of whose rental units are equipped with the Wireless Humidity Monitors, and each building record in the database includes a geographic location of the respective building, which the alarm server uses to query the Meteorological Cloud Server(s) for the current outdoor temperature at that respective geographic location for use in setting the appropriate set-point value for the building at said location.

Since various modifications can be made in the disclosed invention as herein above described, and many apparently widely different embodiments of same made, it is intended that all matter contained in the accompanying specification shall be interpreted as illustrative only and not in a limiting sense.

1. A computer-implemented method of preventing or mitigating mold growth, said method comprising:
(a) within an indoor environment to be monitored, automatically measuring a current relative humidity value of said indoor environment;
(b) automatically obtaining a current outdoor temperature, and based on said current outdoor temperature, automatically adjusting a humidity alarm set point;
(c) automatically comparing said humidity alarm set point against said current relative humidity value in the indoor environment; and
(d) in response to determination that said current relative humidity value exceeds the humidity alarm set point, providing an alert to one or more personnel.

2. The method of claim 1 wherein step (b) comprises obtaining said current outdoor temperature from one or more meteorological servers situated remotely from said indoor environment.

3. The method of claim 2 wherein step (a) further comprises forwarding said current relative humidity value to an alarm server, step (c) comprises obtaining of the current outdoor temperature from the one or more meteorological servers by said alarm server and comparison of said humidity alarm set point against said current relative humidity value by said remote alarm server, and step (d) comprises generating and forwarding of the alert by said alarm server.

4. A mold prevention or mitigation system comprising:
one or more humidity monitors installed in an indoor environment and operable to monitor a current relative humidity therein;
an alarm server communicable with said one or more humidity monitors over a data network; and
an internet connection by which the alarm server is communicable with one or more meteorological server that provide current weather data,
wherein the alarm server is configured to receive a current relative humidity value from the one or more humidity monitors, automatically obtain a current outdoor temperature from the one or more meteorological servers, automatically adjust a humidity alarm set point based on said current outdoor temperature, automatically compare said humidity alarm set point against said current relative humidity value, and in response to determination that said current relative humidity value exceeds the humidity alarm set point, send an alert to one or more personnel.
